(19) United States
(12) Patent Application Publication
(10) Pub. No.: US 2026/0128588 A1
(43) Pub. Date: May 7, 2026

(54) ELECTRICAL POWER SYSTEM EQUIPMENT CRITICALITY

(71) Applicant: Quanta Technology, LLC, Raleigh, NC (US)

(72) Inventors: Srinivas Varadan, Cary, NC (US); Khoi Vu, Cary, NC (US)

(21) Appl. No.: 18/935,764

(22) Filed: Nov. 4, 2024

(51) Int. Cl. H02J 3/00; G06Q 30/0201; G06Q 50/06

(52) U.S. Cl. CPC H02J 3/0012; G06Q 30/0206; G06Q 50/06; H02J 3/003

(57) ABSTRACT

Contingency analysis is executed to simulate operation of an electrical power system under different contingencies that reflect an individual outage of different respective pieces of equipment in the system. For each of the different contingencies, it is quantified how impactful the individual outage of the respective piece of equipment would be to the system's performance. For example, this may be quantified across multiple dimensions of performance, by calculating dimension-specific scores for the respective dimensions and synthesizing the dimension-specific scores into a unified criticality score for a piece of equipment. Regardless, the criticality scores for the pieces of equipment may better inform control of the electrical power system.

### TECHNICAL FIELD

The present application relates generally to an electrical power system, and relates more particularly to managing pieces of equipment in such a system based on equipment criticality.

### BACKGROUND

Electrical power companies face challenges in managing system infrastructure to ensure reliable and efficient power generation, transmission, and/or distribution. Assets of system infrastructure include many pieces of equipment, though, each with varying degrees of importance and potential for failure. Effective equipment management within resource constraints is paramount, requiring power companies to decide (i) which pieces of equipment to maintain, repair, replace, upgrade, or otherwise give attention to and (ii) when to do so. If a piece of equipment is not given this sort of attention before its failure, grid reliability and availability can be compromised. On the other hand, if a piece of equipment is given attention needlessly and/or prematurely, there may not be enough budget or other resources remaining to give attention to other pieces of equipment.

Known approaches to address these challenges rank pieces of equipment in the power system according to prioritization criteria, and then use that ranking to drive equipment management and investment actions. Equipment prioritization in some approaches is performed as a function of equipment voltage class and equipment power rating, with equipment having a higher voltage class and a higher power rating being prioritized over equipment with a lower voltage class and a lower power rating. Equipment prioritization in other approaches is performed based on an estimate of each piece of equipment's so-called “risk of failure”, calculated as the product of the equipment's probability of failure and the equipment's consequence of failure. The risk of failure in this case is estimated based on various factors such as the condition of the equipment, the age of the equipment, the operational stresses endured by the equipment, and the characteristic life of the equipment's asset class. These known approaches thereby rely on equipment-specific information that proves relevant irrespective of the operating environment in which a piece of equipment is deployed and/or long-term statistics observed for different types of equipment.

Known approaches nonetheless still prove susceptible to inaccuracies, especially as system operating conditions change and/or at a fleet level. A need therefore remains for prioritizing pieces of equipment in a power system in a way that more accurately reflects equipment criticality relevant to equipment management and investment decisions, even as system operating conditions vary.

### SUMMARY

Embodiments herein exploit contingency analysis to quantify how critical respective pieces of equipment are to an electrical power system. Contingency analysis in this regard involves simulating operation of the electrical power system under different contingencies that reflect an individual outage of different respective pieces of equipment in the electrical power system. Contingency analysis thereby advantageously captures the operating environment in which each piece of equipment is deployed, so that the piece of equipment's criticality accounts for that operating environment. Even as system operating conditions change over time, then, pieces of equipment may be prioritized in a way that more accurately reflects equipment criticality relevant for driving equipment management and investment action.

Quantifying equipment criticality in some embodiments may for example involve, for each of the contingencies simulated, quantifying how impactful the individual outage of each respective piece of equipment would be across multiple dimensions of the electrical power system's performance. This may be quantified for instance by synthesizing dimension-specific scores for the multiple dimensions into a unified criticality score for each piece of equipment. These unified criticality scores may then drive control and/or management of the electrical power system.

Some embodiments accordingly better promote system resilience and reliability, safeguarding against disruptions and ensuring stable electrical power delivery to consumers. Alternatively or additionally, some embodiments assist electrical power system operators in prioritizing equipment for maintenance and/or replacement, allowing for more informed and strategic planning, to enhance overall system performance and sustainability. Such may prove particularly advantageous in the face of limited annual budgets, where proper prioritization of equipment investment optimizes resource allocation and ensures long-term system health and efficiency.

More particularly, embodiments herein include a method. The method comprises executing contingency analysis by simulating operation of an electrical power system under different contingencies that reflect an individual outage of different respective pieces of equipment in the electrical power system. The method also comprises, for each of the different contingencies, quantifying how impactful the individual outage of the respective piece of equipment would be to the electrical power system's performance, i.e., in terms of criticality scores for the respective pieces of equipment. The method also comprises, based on the criticality scores for the pieces of equipment, controlling or assisting with controlling the electrical power system, e.g., by dynamically adjusting one or more operational parameters of the electrical power system and/or a graphical user interface of operational control equipment of the electrical power system, to account for the unified criticality scores for the pieces of equipment.

In some embodiments, how impactful the individual outage of each respective piece of equipment would be to the electrical power system's performance may be quantified across multiple dimensions of the electrical power system's performance. In one or more such embodiments, the quantifying comprises, for each of the multiple dimensions, calculating a dimension-specific score which characterizes performance of the electrical power system in that dimension according to the simulated operation of the electrical power system under the contingency, relative to performance of the electrical power system in the dimension according to baseline operation of the electrical power system without the contingency. In some embodiments, the quantifying then comprises synthesizing the dimension-specific scores for the multiple dimensions into a unified criticality score for the piece of equipment.

Other embodiments herein include corresponding apparatus, computer programs, and carriers of those computer programs, e.g., in the form of a non-transitory computer-readable storage medium on which the computer program is stored.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of an electrical power system and operational control equipment according to some embodiments.

FIG. 2 is a block diagram of criticality scoring for a piece of equipment according to some embodiments.

FIG. 3 is a block diagram of criticality scoring for a piece of equipment according to other embodiments.

FIG. 4A is a table of criticality scores for example transformers according to conventional criticality scoring approaches.

FIG. 4B is a bar chart of criticality scores for example transformers according to conventional criticality scoring approaches.

FIG. 5A is a table of criticality scores for example transformers according to one or more embodiments herein.

FIG. 5B is a bar chart of criticality scores for example transformers according to one or more embodiments herein.

FIG. 5C is a table of criticality scores for example transformers according to one or more other embodiments herein.

FIG. 6 is a logic flow chart of a method according to some embodiments herein.

FIG. 7 is a block diagram of computing equipment according to some embodiments herein.

### DETAILED DESCRIPTION

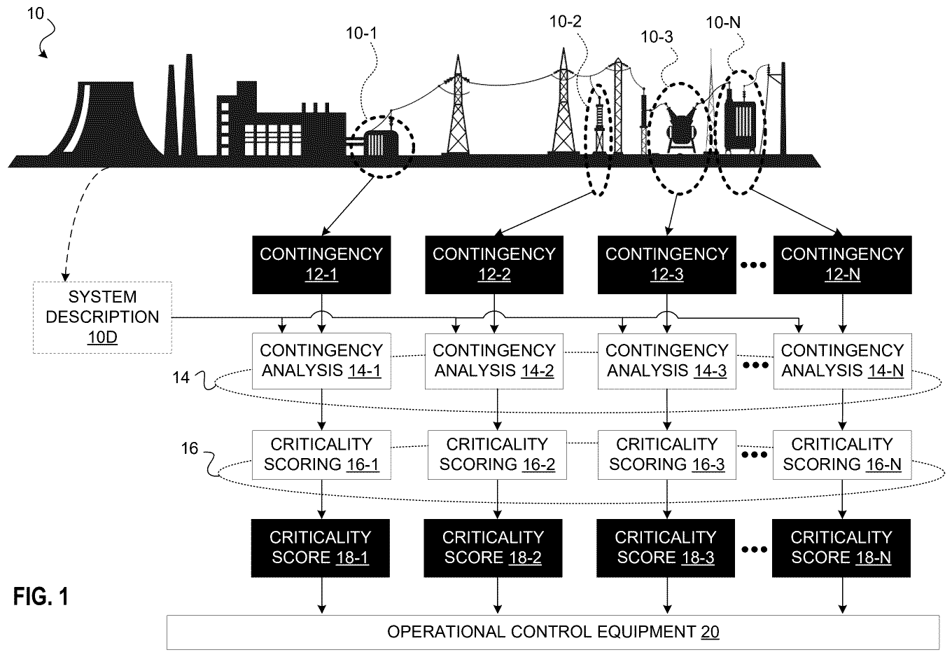

FIG. 1 shows an electrical power system 10 according to some embodiments, e.g., in the form of an electric utility system. The electrical power system 10 includes multiple pieces of equipment, as assets of the system 10, e.g., for generation, transmission, and/or distribution of electrical power. In FIG. 1, the electrical power system 10 is exemplified as having at least N pieces of equipment 10-1, . . . 10-N that are relevant to embodiments herein. These N pieces of equipment 10-1 . . . 10-N may span multiple types of equipment, such as transformers, generators, and transmission lines. Or, the N pieces of equipment 10-1 . . . 10-N may be limited to different pieces of the same type of equipment, e.g., N power transformers. Here, N may be very large, e.g., thousands in a large power system.

For each of these N respective pieces of equipment 10-1, . . . 10-N, embodiments herein quantify how critical that piece of equipment 10-n is to the electrical power system 10, with 1≤n≤N. Embodiments quantify the criticality of a piece of equipment 10-n in terms of how impactful an individual outage of that piece of equipment 10-n would be to the electrical power system's performance. Here, the individual outage of a piece of equipment 10-n refers to a planned or unplanned condition where that individual piece of equipment 10-n is temporarily non-operational or unavailable for use, e.g., as a result of a fault, failure, or external disturbance, while the other pieces of equipment remain operational and available for use. During an outage of a piece of equipment 10-n, then, that piece of equipment 10-n cannot perform its intended function. The piece of equipment 10-n not performing its intended function may subject other pieces of equipment to increased loading and otherwise threaten to impact system performance, e.g., potential overloads, operational standard violations, etc. The more critical a piece of equipment 10-n, the more impactful the individual outage of that piece of equipment 10-n will be on the electrical power system's performance. In order to determine how impactful the individual outage of each piece of equipment 10-1, . . . 10-N would be, and thus how critical each piece of equipment is, embodiments herein notably exploit contingency analysis 14.

Contingency analysis 14 postulates the individual outage of different pieces of equipment 10-1, . . . 10-N as respective contingencies 12-1, . . . 12-N under which operation of the electrical power system 10 is to be simulated. FIG. 1 shows in this example that contingency 12-1 reflects the individual outage of a piece of equipment 10-1, contingency 12-2 reflects the individual outage of a different piece of equipment 10-2, and so on. Contingency analysis 14 accordingly simulates operation of the electrical power system 10 under these different contingencies 12-1 . . . 12-N. In particular, contingency analysis 14-1 simulates operation of the electrical power system 10 under the contingency 12-1 that reflects the individual outage of piece of equipment 10-1, contingency analysis 14-2 simulates operation of the electrical power system 10 under the contingency 12-2 that reflects the individual outage of piece of equipment 10-2, etc.

In some embodiments, contingency analysis 14 simulates the transient-state operation of the electrical power system 10, to characterize operation of the electrical power system 10 in the short-term aftermath of the individual outage of a given piece of equipment 10-n. In other embodiments, contingency analysis 14 alternatively or additionally simulates the steady-state operation of the electrical power system 10, to characterize operation of the electrical power system 10 once it has stabilized after the individual outage of a given piece of equipment 10-n. Such steady-state operation may for instance be simulated using a load flow analysis with the given piece of equipment 10-n removed from the electrical power system 10, whereby load flow analysis reveals the system's steady-state in terms of the voltage magnitude and phase angle at each bus or node in the electrical power system 10 as well as the real and reactive power flows on each transmission line.

In these and other embodiments, the contingency analysis 14 advantageously accounts for the operating environment of each piece of equipment 10-1 . . . 10-N, including for example the location of each piece of equipment 10-1 . . . 10-N in the electrical power system 10 and how those pieces of equipment 10-1 . . . 10-N are interconnected, i.e., the topology of the electrical power system 10. The contingency analysis 14 may also account for the location of power generation and load with respect to the system's topology, the actual values of the loads, as well as the dynamic nature of the loads in the system 10 and thus the loading on each piece of equipment 10-1 . . . 10-N . These and/or other characteristics that wholistically describe the electrical power system 10 may be reflected in a system description 10D that is input to contingency analysis 14. The system description 10D may for instance take the form of data structure(s) or power system file(s) that are understood by contingency analysis 14, e.g., a Power System Simulator for Engineering (PSS/E) file, a Positive Sequence Load Flow (PSLF) file, or an Institute of Electrical and Electronics Engineers Common Format for Transient Data Exchange (IEEE Comtrade) file.

With the results of contingency analysis 14 indicating how the electrical power system 10 would operate in the event of individual outages of the pieces of equipment 10-1 . . . 10-N, the impact of those individual outages may be assessed by evaluating system performance according to the simulated operation under each contingency 12-1 . . . 12-N. Criticality scoring 16 in FIG. 1 makes this assessment in order to quantify how impactful the individual equipment outages would be to the electrical power system's performance. Criticality scoring 16 quantifies this in the form of criticality scores 18-1 . . . 18-N for respective pieces of equipment 10-1 . . . 10-N, i.e., criticality scoring 16-1 calculates criticality score 18-1 for piece of equipment 10-1, criticality scoring 16-2 calculates criticality score 18-2 for piece of equipment 10-2, and so on.

The criticality score 18-n for piece of equipment 10-n quantifies how critical that piece of equipment 10-n is to the electrical power system 10, e.g., in terms of a scalar value that is proportional to a level of criticality, such as a scalar value in the range of 0-100. The criticality score 18-n may do so by effectively reflecting or characterizing performance of the electrical power system 10 according to the simulated operation of the electrical power system under contingency 12-n (reflecting the individual outage of piece of equipment 10-n). The criticality score 18-n may be absolute or relative, in the sense that it may reflect the system's performance in an absolute sense or in a relative sense. For example, in some embodiments where the criticality score 18-n is relative, the criticality score 18-n may reflect or characterize performance of the electrical power system 10 according to the simulated operation of the electrical power system under contingency 12-n, relative to performance of the electrical power system 10 according to some baseline operation of the electrical power system 10 without the contingency 12-n. In either case, by characterizing system performance in the event of an individual outage of a piece of equipment 10-n, the criticality score 18-n for that piece of equipment 10-n effectively quantifies the impact of that equipment's outage.

For example, if, according to the simulated operation of the electrical power system 10 under first and second contingencies 12-1 and 12-2, the individual outage of a first piece of equipment 10-1 causes poorer system performance than the individual outage of a second piece of equipment 10-2, the criticality scores 18-1, 18-2 for those pieces of equipment 10-1, 10-2 will together indicate that the first piece of equipment 10-1 is more critical than the second piece of equipment 10-2, e.g., in embodiments where a greater criticality score indicates greater criticality, criticality score 18-1 will be greater than criticality score 18-2. Criticality scores 18-1 . . . 18-N may thereby effectively rank pieces of equipment 10-1 . . . 10-N in terms of how critical they are to the electrical power system 10, e.g., with pieces of equipment having higher criticality scores (e.g., 100) being ranked higher in terms of criticality than pieces of equipment with lower criticality scores (e.g., 10). Alternatively or additionally, thresholds may be dynamically or statically defined to create different ranges of scores reflective of different categories or classes of criticality. In this case, criticality scores falling within one range of scores (e.g., 0-39) may indicate a “low” level of criticality, criticality scores falling within another range of scores (e.g., 40-79) may indicate a “medium” level of criticality, criticality scores falling within yet another range of scores (e.g., 80-100) may indicate a “high” level of criticality, etc.

In any event, with contingency analysis 14 effectively capturing the operating environment in which each piece of equipment 10-1 . . . 10-n is deployed, the criticality score 18-1 . . . 18-N for each piece of equipment 10-1 . . . 10-N advantageously accounts for that operating environment. The criticality scores 18-1 . . . 18-N may do so even as system operating conditions change over time. In fact, contingency analysis 14 and/or criticality scoring 16 may be executed periodically and/or dynamically on a timescale appropriate for keeping criticality scores 18-1 . . . 18-N updated as needed. In these and other embodiments, then, pieces of equipment 10-1 . . . 10-N may be prioritized in a way that more accurately reflects equipment criticality relevant for driving equipment management and investment action.

FIG. 1 for example shows that in some embodiments the criticality scores 18-1 . . . 18-N are provided as input to operational control equipment 20. Based on the criticality scores 18-1 . . . 18-N the operational control equipment 20 in some embodiments controls, or assists with controlling, the electrical power system 10.

In one such embodiment, the operational control equipment 20 itself makes decisions about how the electrical power system 10 is to be, or is recommended to be, controlled, in view of the criticality scores 18-1 . . . 18-N . These decisions may therefore represent anticipated, planned, or recommended actions, e.g., for mitigating reliability risks. The operational control equipment 20 in such a case may be understood as assisting with controlling operation of the electrical power system 10, by assisting with the planning or recommendation of actions for controlling the electrical power system 10, based on the criticality scores 18-1 . . . 18-N. The operational control equipment 20 may for example transmit, display, or otherwise indicate the planned or recommended actions, e.g., for implementation by the system operator.

The operational control equipment 20 in some embodiments may furthermore carry out those decisions by autonomously implementing them. The operational control equipment 20 may for example dynamically adjust one or more operating parameters of the electrical power system 10, in dependence on one or more of the criticality scores 18-1 . . . 18-N.

The adjusted parameter(s) may for example include parameter(s) that govern load shedding by the electrical power system 10. The operational control equipment 20 may for instance adjust load shedding to be more aggressive towards pieces of equipment 10-1 . . . 10-N that the criticality scores 18-1 . . . 18-N indicate are more critical, so as to more aggressively alleviate loading on and otherwise protect those more critical pieces of equipment.

Alternatively or additionally, the adjusted parameter(s) may include parameter(s) that govern voltage and/or frequency regulation by the electrical power system 10. The operational control equipment 20 may for instance adjust voltage and/or frequency regulation to more conservatively keep voltage levels of more critical pieces of equipment within specified limits and/or adjust those limits to be more conservative for more critical pieces of equipment. The operational equipment 20 in one or more embodiments may effectively derate more critical pieces of equipment, e.g., to better ensure that those more critical pieces of equipment do not fail.

Alternatively or additionally, the adjusted parameter(s) may include parameter(s) that govern energy storage by the electrical power system 10 and/or integration of renewable energy sources into the electrical power system 10. The operational control equipment 20 may for instance more aggressively store energy as needed to create more reserve capacity for guarding against instability that would jeopardize more critical pieces of equipment. Here, ‘reserve’ refers to additional generating capacity reserved for meeting sudden demand spikes or for compensating for unexpected generation losses. Or, the operational control equipment 20 may integrate or de-integrate some renewable energy storage sources, as needed to either create additional reserve capacity or reduce instability concerns for protecting against outages of more critical pieces of equipment.

Alternatively or additionally, the adjusted parameter(s) may include parameter(s) that govern participating by the electrical power system 10 in a bulk energy market.

Alternatively or additionally, the adjusted parameter(s) may include parameter(s) that govern power flow control and network reconfiguration within the electrical power system 10.

Alternatively or additionally, the adjusted parameter(s) may include parameter(s) that govern the coordination between transmission and distribution systems within the electrical power system.

Alternatively or additionally, the adjusted parameter(s) may include parameter(s) that govern congestion limits in line flows affecting market clearing prices.

In still other embodiments, the operational control equipment 20 may dynamically control one or more pieces of equipment 10-1 . . . 10-N based on one or more of the criticality scores 18-1 . . . 18-N, e.g., based on one or more of the criticality scores 18-1 . . . 18-N exceeding a predefined threshold. For example, if the criticality score 18-n for a piece of equipment 10-n exceeds a predefined threshold, the operational control equipment 20 may control, or assist with controlling, the electrical power system 10 to re-route power flow through another path to alleviate the impact on the electrical power system 10 in the aftermath of equipment 10-n going out of service (e.g., either by schedule, or a random failure). This may be associated with de-rating a piece of equipment 10-n that is very critical with a high risk of failure, so that it is operated at a value lower than its nominal rating.

In yet other embodiments, the operational control equipment 20 may alternatively or additionally assist with controlling the electrical power system 10, such as by assisting operator personnel with making decisions about how to control the electrical power system 10 in view of the criticality scores 18-1 . . . 18-N . In some of these embodiments, the operational control equipment 20 may dynamically adjust an associated graphical user interface based on the criticality scores 18-1 . . . 18-N. For example, the operational control equipment 20 may dynamically adjust a visual representation of one or more of the pieces of equipment 10-1 . . . 10-N on the graphical user interface to reflect the one or more respective criticality scores 18-1 . . . 1-N for the one or more of the pieces of equipment 10-1 . . . 10-N. In doing so, the operational control equipment 20 may aim to draw operator attention and action to any pieces of equipment that are most critical, or more critical than others, e.g., as equipment criticality changes over time.

Visual representation adjustment may for example involve one or a combination of the following visualization techniques, to effectively draw operator attention to critical pieces of equipment. In some embodiments, the operational control equipment 20 adjusts the color and/or size of a graphical user interface icon associated with a piece of equipment 10-n, e.g., by changing the icon to be red in color and/or larger in size to indicate a high level of criticality. Alternatively or additionally, the operational control equipment 20 adjusts an opacity of a graphical user interface icon associated with a piece of equipment 10-n, e.g., by changing the icon for a more critical piece of equipment to be opaque and changing the icon for a less critical piece of equipment to be transparent. Alternatively or additionally, the operational control equipment 20 adjusts an extent to which an icon for a piece of equipment 10-n flashes, glows, moves, or is highlighted. For example, the operational control equipment 20 may adjust the icon for a piece of equipment 10-n with a high level of criticality to flash, glow, pulse, or oscillate, and/or to be circled or otherwise highlighted, as compared to the icon for another piece of equipment with a low level of criticality that does not flash, glow, pulse or oscillate and/or is not circled or highlighted. In still other examples, the operational control equipment 20 may adjust visual layering of icons based on criticality scores 18-1 . . . 18-N , e.g., so as to bring an icon for a more critical piece of equipment to the forefront by layering it over other icons for less critical pieces of equipment. In yet other examples, the operational control equipment 20 may adjust a visual listing of more critical pieces of equipment, e.g., by updating a side panel or list to prominently feature icons or textual labels for more critical pieces of equipment, to the exclusion of icons or textual labels for less critical pieces of equipment.

In further embodiments, the operational control equipment 20 alternatively or additionally triggers, based on the criticality scores 18-1 . . . 18-N, an alert notification on a graphical user interface associated with the operational control equipment 20. The alert notification may for instance be a notification of an event triggered by one or more of the criticality scores 18-1 . . . 18-N. Such an event may be that the criticality score 18-n for a given piece of equipment 10-n has exceeded a predefined or configurable threshold, e.g., reflecting that the piece of equipment 18-n has become very critical. The operational control equipment 20 in such a case may selectively trigger alert notifications on the graphical user interface only when the criticality for pieces of equipment 10-1 . . . 10-N reaches a level that demands operator attention.

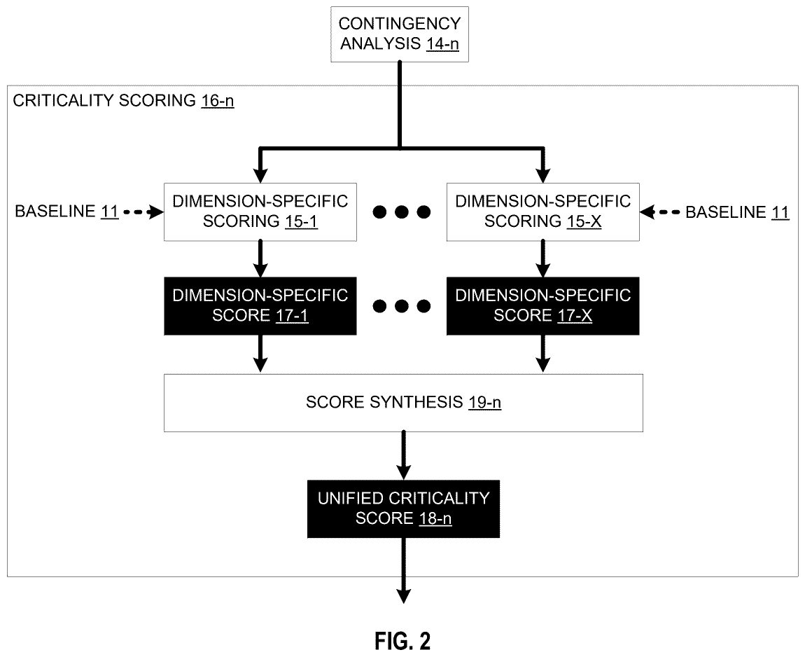

Consider now additional details about how criticality scoring 16 calculates criticality scores 18-1 . . . 18-N according to some embodiments that account for the electrical power system's performance having multiple dimensions. Indeed, the system's performance may be characterized from multiple perspectives (i.e., dimensions) that provide unique insights into how well the electrical power system 10 meets its objectives, e.g., in terms of its technical effectiveness, its cost effectiveness or marketability, its reliability, its efficiency, and/or its environmental friendliness. In one or more of these embodiments in this regard, criticality scoring 16 calculates the criticality score 18-n for each piece of equipment 10-n in such a way that it effectively quantifies how impactful the individual outage of the piece of equipment 10-n would be across multiple dimensions of the electrical power system's performance. Rather than the criticality score 18-n for a piece of equipment 10-n only reflecting one dimension of the electrical power system's performance, then, the criticality score 18-n in these embodiments effectively reflects multiple dimensions of the system's performance in a unified way. The criticality score 18-n may thereby appropriately be referred to as a unified criticality score 18-n in such embodiments. FIG. 2 shows one such embodiment for how to calculate a unified criticality score 18-n.

As shown in FIG. 2, criticality scoring 16-n calculates a unified criticality score 18-n for a piece of equipment 10-n using dimension-specific scoring 15-1 . . . 15-X that calculates dimension-specific scores 17-1 . . . 17-X for the piece of equipment 10-n. That is, for each of X multiple dimensions, dimension-specific scoring 14-x calculates a dimension-specific score 17-x for the piece of equipment 10-n. A dimension-specific score 17-x for the piece of equipment 10-n characterizes performance of the electrical power system 10 in dimension x according to the simulated operation of the electrical power system 10 under the contingency that there is an individual outage of the piece of equipment 10-n. This dimension-specific performance may be represented in or determined from the results of contingency analysis 14-n provided to criticality scoring 16-n. In some embodiments, the dimension-specific score 17-x characterizes this dimension-specific performance in a relative way, e.g., by characterizing the performance in dimension x relative to performance of the electrical power system 10 in the same dimension x according to baseline operation of the electrical power system 10 without the contingency, i.e., without the individual outage of piece of equipment 10-n. In one or more such embodiments, dimension-specific scoring 15-1 . . . 15-X may receive as input baseline information 11 indicating this baseline operation and/or system performance according to this baseline operation.

Regardless, having calculated these dimension-specific scores 17-1 . . . 17-X for the X multiple dimensions, criticality scoring 16-n then involves score synthesis 19-n. Score synthesis 19-n entails synthesizing the dimension-specific scores 17-1 . . . 17-X for X multiple dimensions into a unified criticality score 18-n, e.g., according to rule(s), formula(s), and/or algorithm(s) that are either predefined or adaptable to changing conditions. Score synthesis 19-n may for instance do so by calculating the unified criticality score 18-n as a function of a weighted combination of the dimension-specific scores 17-1 . . . 17-X for the X multiple dimensions, e.g., where the dimension-specific scores 17-1 . . . 17-X may be weighted in the combination in proportion to how important each dimension of performance is to the criticality of the piece of equipment 10-n. In such a weighted combination, the weighting may be static, with fixed weights reflecting long-term operational philosophy of the electrical power system's operator. Or, the weighting may be dynamic, with variable weights that adjust based on short-term conditions or long-term changes, such as increasing penetration of renewable energy resources.

In some embodiments, synthesis of the dimension-specific scores 17-1 . . . 17-X into a unified criticality score 18-n presupposes that the dimension-specific scores 17-1 . . . 17-X have values that are on the same scale or in the same range, despite representing system performance in different dimensions. In one or more such embodiments, criticality scoring 16-n may calculate each dimension-specific score 17-x by first calculating a raw score for the dimension x. This raw score may represent the system's performance in the dimension x with a value that falls within a range that is dimension-specific (e.g., 0 to 10,000). Criticality scoring 16-n however then calculates the dimension-specific score 17-x for the dimension x by normalizing this raw score for the dimension x to fall within a dimension-agnostic range (e.g., 0 to 100), e.g., so that the value of the normalized score in the dimension-agnostic range is proportional to the value of the raw score in the dimension-specific range. By doing this for each dimension x, criticality scoring 16-n normalizes raw scores for the different respective dimensions to fall within this same dimension-agnostic range. Synthesis of the dimension-specific scores 17-1 . . . 17-X as normalized may then proceed without the resulting unified criticality score 18-n being biased by differences in the dimension-specific ranges of the dimension-specific scores 17-1 . . . 17-X.

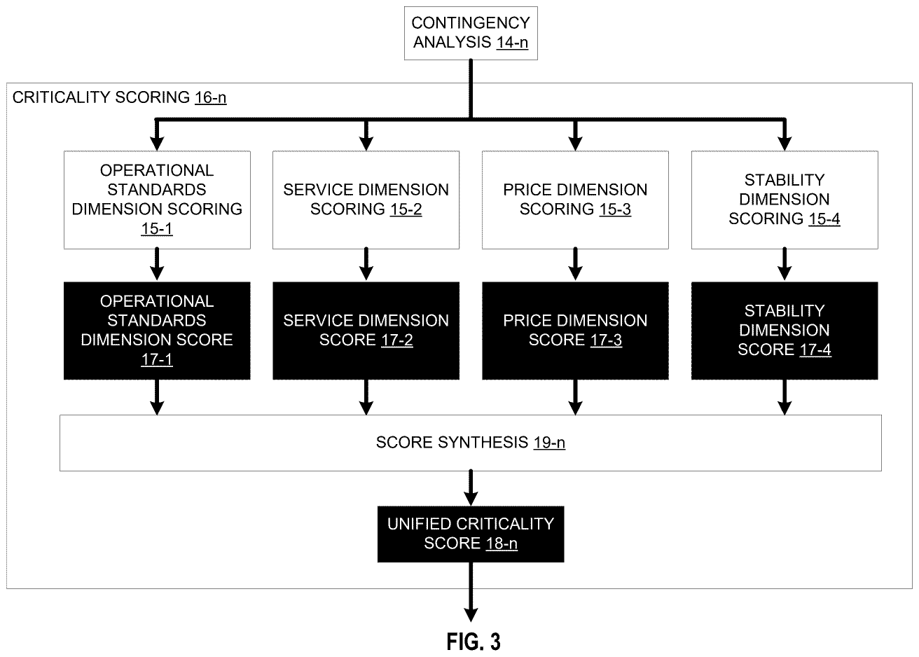

FIG. 3 shows an example for four possible dimensions of the electrical power system's performance. As shown, the performance dimensions in this example include (1) an operational standards dimension; (2) a service dimension; (3) a price dimension; and (4) a stability dimension. As such, criticality scoring 16-n includes operational standards dimension scoring 15-1 that calculates an operational standards dimension score 17-1, service dimension scoring 15-2 that calculates a service dimension score 17-2, price dimension scoring 15-3 that calculates a price dimension score 17-3, and stability dimension scoring 15-4 that calculates a stability dimension score 17-4. Score synthesis 19-n then synthesizes these scores 17-1, 17-2, 17-3, and 17-4 across the dimensions into a unified criticality score 18-n.

The operational standards dimension may reflect an extent to which the electrical power system 10 complies with or violates defined operational standards. The defined operational standards may for example be standards defined for bus voltage limits, branch current limits, equipment power ratings, thermal limits, and/or stability margins in the electrical power system 10. Particularly with regard to equipment power ratings, for instance, the operational standards may effectively define the extent to which loading on a piece of equipment 10-n exceeds its designed capacity, e.g., before operating intervention becomes necessary. Regardless of the particular standards, though, operational standards dimension scoring 15-1 may calculate the operational standards score 17-1 for a given contingency 12-n by calculating the operational standards score 17-1 as a function of (a) a total number of violations of the defined operational standards resulting from the simulated operation of the electrical power system 10 under the contingency 12-n; and/or (b) a magnitude of each violation of the defined operational standards resulting from the simulated operation of the electrical power system 10 under the contingency 12-n. For example, the total number of violations may be calculated as the total number of violations of line flows after the contingency 12-n plus the total number of violations of voltage standards after the contingency 12-n, e.g., COUNT (Line_flows>line_ratings)+COUNT(bus_voltages<voltage_limit). The magnitude of each violation may be captured as the magnitude of the line overflows plus the magnitude of the voltage violations, e.g., SUM(Line_flows-line_ratings, IF(Line_flows>line_ratings)) +SUM(voltage_limit-bus_voltages, IF(bus_voltages<voltage_limit)). In some embodiments, the operational standards dimension scoring 15-1 calculates the operational standards score 17-1 by calculating the weighted sum of (a) and (b), e.g., with user-defined weights, and then normalizing that sum into a dimension-agnostic range, e.g., with the equipment 10-n having the highest score receiving a normalized score of 100. Note that weights for the weighted sum may be configured as desired to wholly disregard the impact of one component of the score or another.

The service dimension may reflect an extent to which the electrical power system 10 is able or unable to provide electrical power service to customers. For example, service dimension scoring 14-2 may calculate the service dimension score 17-2 for a contingency 12-n as a function of (a) how much less electrical power the electrical power system 10 is able to provide to customers according to simulated operation of the electrical power system 10 under the contingency 12-n, e.g., relative to how much electrical power the electrical power system 10 is able to provide to customers according to the baseline operation of the electrical power system 10 without the contingency 12-n. Alternatively or additionally, service dimension scoring 14-2 may calculate the service dimension score 17-2 for a contingency 12-n as a function of (b) how many and/or which one or more types of customers are unable to be provided electrical power from the electrical power system 10 according to simulated operation of the electrical power system 10 under the contingency 12-n, e.g., relative to how many and/or which one or more types of customers are able to be provided electrical power from the electrical power system 10 according to the baseline operation of the electrical power system 10 without the contingency 12-n. In some embodiments, the service dimension scoring 15-2 calculates the service dimension score 17-2 by calculating the sum of (a) and (b), and then normalizing that sum into the dimension-agnostic range.

The price dimension may reflect market pricing of electrical power provided by the electrical power system 10. Price dimension scoring 15-3 in this case may calculate the price dimension score 17-3 for a contingency 12-n as a function of market pricing for each of one or more locations served by the electrical power system 10. For example, price dimension scoring 15-3 may calculate the price dimension score 17-3 as a function of, for each location, how much a locational marginal price of electrical power provided by the electrical power system 10 increases for the location according to simulated operation of the electrical power system 10 under the contingency 12-n, e.g., relative to the baseline operation of the electrical power system without the contingency 12-n. Alternatively or additionally, price dimension scoring 15-3 may calculate the price dimension score 17-3 as a function of how many locations served by the electrical power system 10 see at least a threshold increase in a locational marginal price of electrical power provided by the electrical power system 10 according to simulated operation of the electrical power system 10 under the contingency 12-n, e.g., relative to the baseline operation of the electrical power system 10 without the contingency 12-n.

Alternatively or additionally, price dimension scoring 15-3 may calculate the price dimension score 17-3 as a function of a so-called cost of re-dispatch. This is the estimated cost that would be incurred by an operator of the electrical power system 10 to implement control measures to mitigate, for one or more locations, an increase in a locational marginal price of electrical power provided by the electrical power system 10 according to simulated operation of the electrical power system 10 under the contingency 12-n, e.g., relative to the baseline operation of the electrical power system 10 without the contingency 12-n. Here, control measures might involve simply adjusting the output of several generators, or they may involve reconfiguring the power delivery system or even shedding some loads. The cost of re-dispatch in simple terms may be framed as the Total Cost of Power Production after the contingency 12-n minus the Total Cost of Power Production before the contingency 12-n. For example, consider a system with a total load of 100 MW. Before the contingency, the least-cost generation dispatch totals $15 per hour. After the contingency, redispatch is required to alleviate line overloads and voltage violations. Consequently, some low-cost generators must reduce their output while higher-cost generators increase theirs to continue serving the 100 MW load. This redispatch is determined by a security-constrained economic dispatch program, resulting in a new cost of $20 per hour. Therefore, in this example, the Cost of Redispatch is $20 per hour minus $15 per hour=$5 per hour.

Alternatively or additionally, price dimension scoring 15-3 may calculate the price dimension score 17-3 as a function of an estimated loss of revenue suffered by an operator of the electrical power system 10 attributable to occurrence of the contingency 12-n. Some embodiments in this regard account for two primary facets of revenue loss.

The first facet relates to unserved energy, which occurs when a contingency 12-n results in service disruptions for a group of customers, with the worst-case scenario being a blackout. Some embodiments attribute the economic impact per MWh or hour of lost power across various sectors, e.g., according to industry surveys that provide anecdotal evidence. For instance, “batch manufacturing” might incur losses as high as $140,000 per outage event.

The second facet involves the costs the utility must bear when equipment associated with a contingency 12-n is out of service. If a replacement part is not immediately available in inventory, the system operator will need to order a new one, potentially facing supply-chain delays. During these delays, the system operator may have to implement temporary solutions, such as deploying mobile equipment (if applicable), or purchasing power from more expensive sources due to the unavailability of the usual path through the outaged equipment 10-n, or rely on contracted labor that is much more expensive than in-house labor.

The stability dimension may reflect an extent to which the electrical power system 10 is stable or unstable. Stability dimension scoring 15-4 may calculate the stability dimension score 17-4 as a function of how much more generating capacity the electrical power system 10 must have in reserve to meet a stability target according to simulated operation of the electrical power system 10 under the contingency 12-n, e.g., relative to how much generating capacity the electrical power system 10 must have in reserve to meet the stability target according to the baseline operation of the electrical power system 10 without the contingency 12-n.

Alternatively or additionally, stability dimension scoring 15-4 may calculate the stability dimension score 17-4 as a function of an estimated cost that would be incurred by an operator of the electrical power system 10 to implement control measures to mitigate an increase in generating capacity which the electrical power system 10 must have in reserve to meet a stability target according to simulated operation of the electrical power system 10 under the contingency 12-n, e.g., relative to the baseline operation of the electrical power system 10 without the contingency 12-n.

More particularly in this regard, the control measures may include procuring additional reserve capacity to ensure that enough generating power is available to handle the contingency 12-n. This procurement comes with associated costs. Alternatively or additionally, the control measures may include redispatching generators—altering the planned generation schedule—to maintain grid stability, again at an increased cost. In terms of the stability dimension score 17-4, it may quantify the change in reserve capacity requirements and/or represent the financial implications of the control measures required to maintain stability. This can include the dollar cost of procuring additional reserves, the dollar cost of redispatching generation, and/or any other expenses directly associated with mitigating the impact of the contingency 12-n.

Note that this is just an example, and that the unified criticality score 18-n may be synthesized from just some of the illustrated dimensions and/or from other dimensions not explicitly exemplified. Furthermore, the unified criticality score 18-n for a piece of equipment 10-n may be calculated as a function also of one or more other inputs 21-n. That is, the unified criticality score 18-n may be calculated not only as a function of the dimension-specific scores 17-1 . . . 17-X but also as a function of one or more other inputs 21-n. The other input(s) 21-n may for example include an age of the piece of equipment 10-n, an estimated cost to repair the piece of equipment 10-n and/or to access the piece of equipment 10-n for repair, and/or availability of parts for the piece of equipment 10-n in inventory. Alternatively or additionally, the other input(s) 21-n may include an estimated duration of time required to repair the piece of equipment 10-n, an estimated duration of time required to order and receive a replacement of the piece of equipment 10-n, an availability of a temporary replacement for the piece of equipment 10-n to maintain operations while waiting for a permanent replacement for the piece of equipment 10-n, a frequency of past failures and/or historical reliability data for the piece of equipment 10-n, and/or an extent of redundancy within the electrical power system for the piece of equipment 10-n (e.g., whether alternative equipment or pathways are available to mitigate the impact of a failure of the piece of equipment 10-n). In further embodiments, the other input(s) 21-n may include a voltage class of the piece of equipment 10-n and/or an electrical power rating of the piece of equipment 10-n. Generally, then, these other input(s) may represent any a priori information that directly or indirectly indicates the risk of a piece of equipment 10-n having an outage and/or the impact of a piece of equipment 10-n having an outage. The other input(s) in these and other embodiments may be location-specific and/or may significantly impact the criticality score 18-n for a piece of equipment 10-n.

Now consider a simple example that contrasts a conventional criticality quantification approach with some embodiments herein. In this example, a small utility has 10 substations with one power transformer in each of these ten substations, where these 10 power transformers exemplify pieces of equipment 10-1 . . . 10-10. Two of the transformers are 500 KV transformers and eight of the transformers are 230 KV transformers.

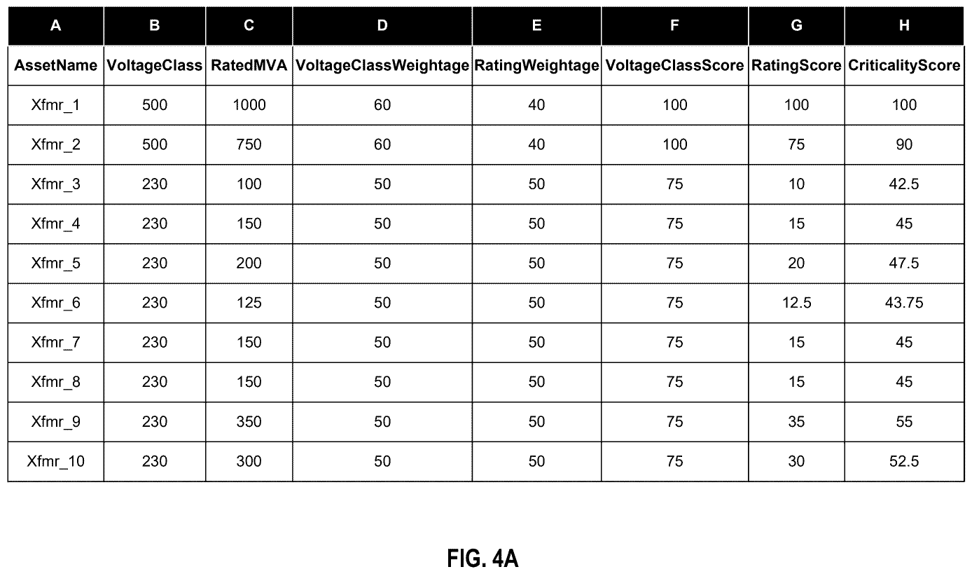

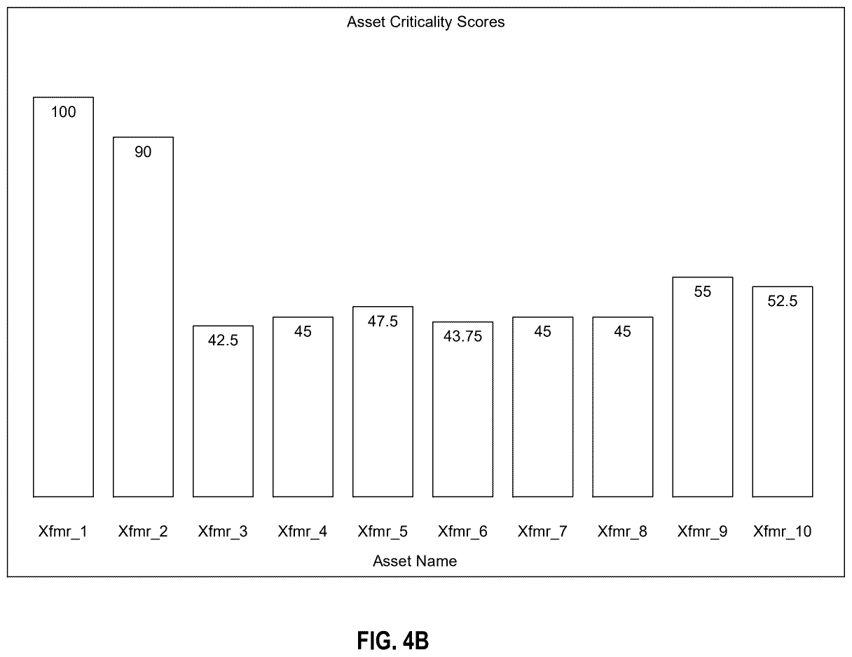

FIGS. 4A-4B show one conventional approach to ranking the power transformers in terms of how critical they are. This conventional approach assigns a criticality score to each transformer. A numbering scale from 0 to 100 is used, where the highest criticality is designated 100 and the lowest 0. The higher the voltage level or rating, the higher the criticality. The criticality score for each transformer is calculated as a function of the Voltage Level (VoltageClass) and Rating (RatedMVA) of the transformer. As shown in the example of FIG. 4A, the criticality score is calculated as follows:
1. Set the VoltageClassScore for a transformer to 100 if the transformer is a 500 KV transformer. Else set it to 75.
2. Set the RatingScore for a transformer equal to the RatedMVA divided by 10.
3. The CriticalityScore for the transformer is obtained as the weighted sum of the VoltageClassScore and the RatingScore, with the VoltageClassScore accounting for 60% of the CriticalityScore and the RatingScore accounting for 40% of the CriticalityScore in the weighted sum, i.e., CriticalityScore=(0.4)RatingScore+(0.6)VoltageClassScore. More generally, the CriticalityScore may be understood as H=(D*F+E*G)/(D+E), where D, E, F, G, and H are the column labels in FIG. 4A corresponding to the respective variables.

FIG. 4B shows the resulting CriticalityScores when calculated according to the conventional approach in FIG. 4A. As seen, transformers 1 and 2 have the same VoltageClass, but have different CriticalityScores depending on RatedMVA. Transformers 7 and 8 have the same VoltageClass and the same RatedMVA, so their CriticalityScores are the same. The conventional approach therefore lacks consideration for the location of each transformer in the electrical power system, the topology of the electrical power system, the location of generation or load on the electrical power system, the actual load or generation on the electrical power system, and/or other factors such as Fire Hazard, Quality of Load Served, etc. Generally, then, the conventional approach overlooks the connectivity of the electrical power system and does not account for the impact on remaining pieces of equipment and/or necessary operator interventions.

Some embodiments herein by contrast calculate the CriticalityScore in a way that effectively accounts for one or more of the aspects overlooked by conventional approaches. For example, continuing the example where pieces of equipment 10-1 . . . 10-N are transformers, some embodiments calculate the CriticalityScore based on the location of each transformer in the electrical power system, the topology of the electrical power system, the location of generation or load on the electrical power system, the actual load or generation on the electrical power system, and/or other factors such as Fire Hazard, Quality of Load Served, etc. Generally, then, the conventional approach overlooks the connectivity of the electrical power system and does not account for the impact on remaining pieces of equipment and/or necessary operator interventions.

In particular, some embodiments perform an (n-1) contingency analysis for each transformer. This contingency analysis may be performed for instance based on a PSS/E file, a PSLF file, or an IEEE Comtrade file, which contains the electrical topology of the electrical power system, contains the location of generation and loads, contains the actual value of the loads, etc. The results of the contingency analysis for each transformer are analyzed (e.g., with load flow analysis) to count the number of bus voltage violations and branch current violations that would occur if the transformer were to fail. The CriticalityScore is calculated as a function of the total number of violations, as well as the magnitude of those violations, scaled to fall within a range of 0-100. In some embodiments, the CriticalityScore may be calculated also as a function of the quality of load served, ability to cause fires, etc.

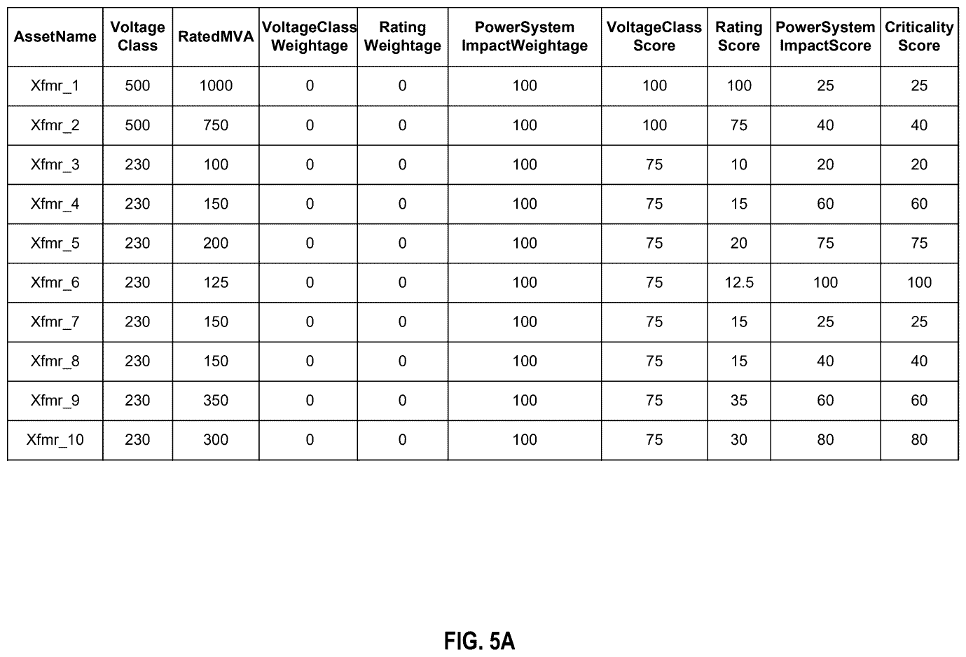

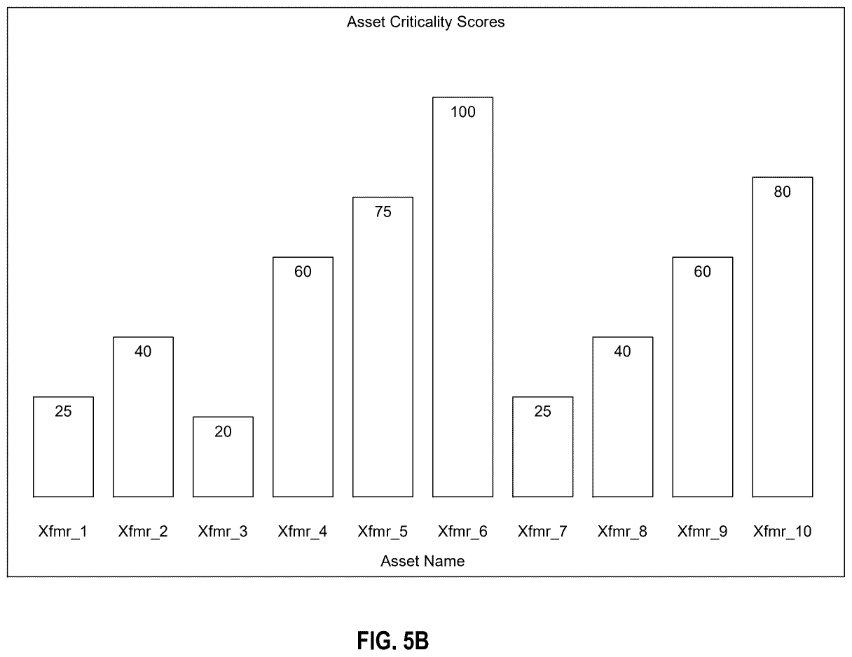

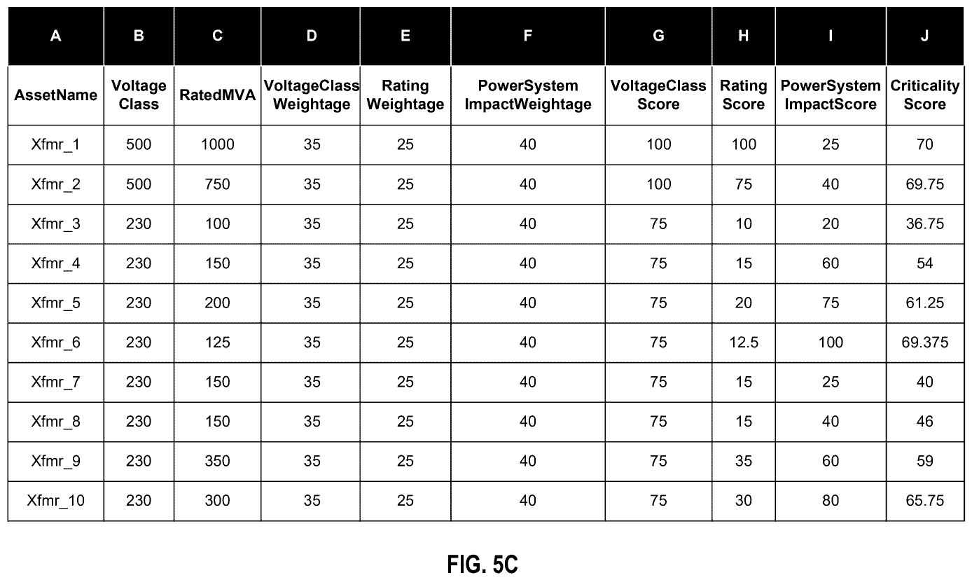

FIGS. 5A-5B show the CriticalityScore when calculated in this way, without any regard to the VoltageClass or RatedMVA in order to highlight the impact of this new approach (i.e., with the VoltageClass Weightage set to 0 and the Rating Weightage set to 0). In this case, the CriticalityScores may differ considerably from the conventional approach. Indeed, according to the analysis of the contingency in which transformer 6 fails, the outage of transformer 6 would cause the greatest number of violations and/or the most severe violations, despite it being of lower voltage class and lower rating than some other transformers. As such, transformer 6 is deemed as having the most impact on the power system 10, with a PowerSystemImpactScore=100. Conversely, according to the analysis of the contingency in which transformer 1 fails, the outage of transformer 1 would cause a fewer number of violations and/or less severe violations, despite it being of higher voltage class and higher rating than some other transformers. As such, transformer 1 is deemed as having one of the smallest impacts on the power system 10, with a PowerSystemImpactScore=25. In this example highlighting the impact on the power system 10 as contributing to the criticality score, these contributions from the PowerSystemImpactScore contribute 100% to the ultimate CriticalityScore, i.e., CriticalityScore is equal to PowerSystemImpactScore, such that transformer 6 has a CriticlaityScore=100, transformer 1 has a CriticalityScore=25, etc.

FIG. 5C illustrates another example, though, where the VoltageClass and the RatedMVA also contribute to the CriticalityScore, i.e., where VoltageClass and RatedMVA exemplify the other input(s) 21-n. As shown, The VoltageClass Weightage is set to 35, the Rating Weightage set to 25, and the PowerSystem ImpactWeightage is set to 40, so that the VoltageClass contributed 35% of the CriticalityScore, the RatedMVA contributes 25% of the CriticalityScore, and the PowerSystem ImpactScore contributes 40% of the CriticalityScore. More generally, then, the CriticalityScore may be understood as J=(D*G+E*H+F*I)/(D+E+F), where D, E, F, G, H, I, and J are the column labels in FIG. 5C corresponding to the respective variables.

Some embodiments nonetheless enable a user of operational control equipment 20 to override or bias the criticality score 18-n for a piece of equipment 10-n, as needed for the criticality score 18-n to represent the true criticality of the piece of equipment 10-n to the user. In fact, in some embodiments, the user may create an override or bias as a custom or persistent rule for adjusting criticality scores for the piece of equipment 10-n, or for certain types of equipment. This may enhance the adaptability and/or accuracy of criticality scoring over time, e.g., so that criticality scoring may learn and adapt over time based on user feedback).

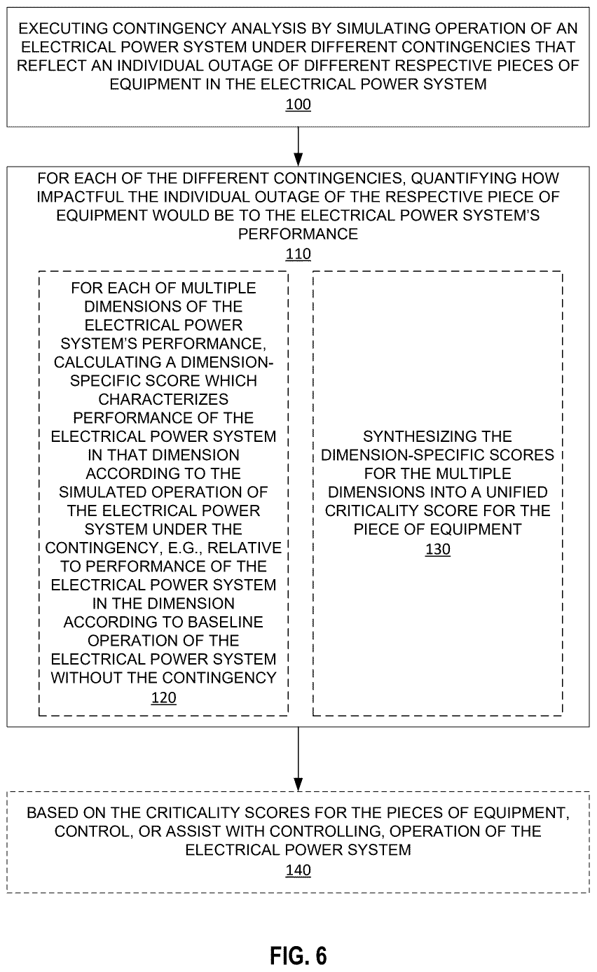

In view of the modifications and variations herein, FIG. 6 depicts a method, e.g., performed by computing equipment of an electrical power system 10, in accordance with particular embodiments. The method includes executing contingency analysis 14 by simulating operation of an electrical power system 10 under different contingencies 12 that reflect an individual outage of different respective pieces of equipment 10-1 . . . 10-N in the electrical power system 10 (Block 100). The method also comprises, for each of the different contingencies 12, quantifying how impactful the individual outage of the respective piece of equipment 10-1 . . . 10-N would be to the electrical power system's performance (Block 110), e.g., in terms of criticality scores 18-1 . . . 18-N for the respective pieces of equipment 10-1 . . . 10-N.

In some embodiments, the quantifying comprises quantifying how impactful the individual outage of the respective piece of equipment 10-1 . . . 10-N would be to the electrical power system's performance comprises quantifying how impactful the individual outage of the respective piece of equipment 10-1 . . . 10-N would be across multiple dimensions of the electrical power system's performance. In this case, quantifying entails, for each of the multiple dimensions, calculating a dimension-specific score 17-n which characterizes performance of the electrical power system 10 in that dimension according to the simulated operation of the electrical power system 10 under the contingency 12-n, e.g., relative to performance of the electrical power system 10 in the dimension according to baseline operation of the electrical power system 10 without the contingency 12-n (Block 120). Quantifying then comprises synthesizing the dimension-specific scores 17-1 . . . 17-X for the multiple dimensions into a unified criticality score 18- n for the piece of equipment 10-1 . . . 10-N (Block 130).

Regardless, the method in some embodiments also comprises, based on the criticality scores 18-1 . . . 18-N for the pieces of equipment 10-1 . . . 10-N, controlling, or assisting with controlling, operation of the electrical power system 10 (Block 140).

In some embodiments where how impactful the individual outage of the respective piece of equipment 10-1 . . . 10-N would be is quantified across multiple dimensions of the electrical power system's performance, the multiple dimensions of the electrical power system's performance include at least an operational standards dimension reflecting an extent to which the electrical power system 10 complies with or violates defined operational standards. In other embodiments, the multiple dimensions of the electrical power system's performance include alternatively or additionally at least a service dimension reflecting an extent to which the electrical power system 10 is able or unable to provide electrical power service to customers. In yet other embodiments, the multiple dimensions of the electrical power system's performance include alternatively or additionally at least a price dimension reflecting market pricing of electrical power provided by the electrical power system 10. In still yet other embodiments, the multiple dimensions of the electrical power system's performance include alternatively or additionally at least a stability dimension reflecting an extent to which the electrical power system 10 is stable or unstable.

In some embodiments where how impactful the individual outage of the respective piece of equipment 10-1 . . . 10-N would be is quantified across multiple dimensions of the electrical power system's performance, the multiple dimensions of the electrical power system's performance include an operational standards dimension reflecting an extent to which the electrical power system 10 complies with or violates defined operational standards. In some embodiments, the defined operational standards comprise bus voltage limits, branch current limits, equipment power ratings, and/or stability margins. In some embodiments, for each of the different contingencies 12, calculating the dimension-specific score 17-n for the operational standards dimension comprises calculating the dimension-specific score 17-n as a function of a total number of violations of the defined operational standards resulting from the simulated operation of the electrical power system 10 under the contingency 12-n. In other embodiments, for each of the different contingencies 12, calculating the dimension-specific score 17-n for the operational standards dimension comprises calculating the dimension-specific score 17-n alternatively or additionally as a function of a magnitude of each violation of the defined operational standards resulting from the simulated operation of the electrical power system 10 under the contingency 12-n.

In some embodiments where how impactful the individual outage of the respective piece of equipment 10-1 . . . 10-N would be is quantified across multiple dimensions of the electrical power system's performance, the multiple dimensions of the electrical power system's performance include a service dimension reflecting an extent to which the electrical power system 10 is able or unable to provide electrical power service to customers. In some embodiments, for each of the different contingencies 12, calculating the dimension-specific score 17-n for the service dimension comprises calculating the dimension-specific score 17-n as a function of how much less electrical power the electrical power system 10 is able to provide to customers according to simulated operation of the electrical power system 10 under the contingency 12-n, relative to how much electrical power the electrical power system 10 is able to provide to customers according to the baseline operation of the electrical power system 10 without the contingency 12-n. In other embodiments, for each of the different contingencies 12, calculating the dimension-specific score 17-n for the service dimension comprises calculating the dimension-specific score 17-n alternatively or additionally as a function of how many and/or which one or more types of customers are unable to be provided electrical power from the electrical power system 10 according to simulated operation of the electrical power system 10 under the contingency 12-n, relative to how many and/or which one or more types of customers are able to be provided electrical power from the electrical power system 10 according to the baseline operation of the electrical power system 10 without the contingency 12-n.

In some embodiments where how impactful the individual outage of the respective piece of equipment 10-1 . . . 10-N would be is quantified across multiple dimensions of the electrical power system's performance, the multiple dimensions of the electrical power system's performance include a price dimension reflecting market pricing of electrical power provided by the electrical power system 10. In some embodiments, for each of the different contingencies 12, calculating the dimension-specific score 17-n for the price dimension comprises calculating the dimension-specific score 17-n as a function of for each of one or more locations served by the electrical power system 10, how much a locational marginal price of electrical power provided by the electrical power system 10 increases for the location according to simulated operation of the electrical power system 10 under the contingency 12-n, relative to the baseline operation of the electrical power system 10 without the contingency 12-n. In other embodiments, for each of the different contingencies 12, calculating the dimension-specific score 17-n for the price dimension comprises calculating the dimension-specific score 17-n alternatively or additionally as a function of how many locations served by the electrical power system 10 see at least a threshold increase in a locational marginal price of electrical power provided by the electrical power system 10 according to simulated operation of the electrical power system 10 under the contingency 12-n, relative to the baseline operation of the electrical power system 10 without the contingency 12-n. In yet other embodiments, for each of the different contingencies 12, calculating the dimension-specific score 17-n for the price dimension comprises calculating the dimension-specific score 17-n alternatively or additionally as a function of an estimated cost that would be incurred by an operator of the electrical power system 10 to implement control measures to mitigate, for one or more locations, an increase in a locational marginal price of electrical power provided by the electrical power system 10 according to simulated operation of the electrical power system 10 under the contingency 12-n, relative to the baseline operation of the electrical power system 10 without the contingency 12-n. In still other embodiments, for each of the different contingencies 12, calculating the dimension-specific score 17-n for the price dimension comprises calculating the dimension-specific score 17-n alternatively or additionally as a function of an estimated loss of revenue suffered by an operator of the electrical power system 10 attributable to occurrence of the contingency 12-n.

In some embodiments where how impactful the individual outage of the respective piece of equipment 10-1 . . . 10-N would be is quantified across multiple dimensions of the electrical power system's performance, the multiple dimensions of the electrical power system's performance include a stability dimension reflecting an extent to which the electrical power system 10 is stable or unstable. In some embodiments, for each of the different contingencies 12, calculating the dimension-specific score 17-n for the stability dimension comprises calculating the dimension-specific score 17-n as a function of how much more generating capacity the electrical power system 10 must have in reserve to meet a stability target according to simulated operation of the electrical power system 10 under the contingency 12-n, relative to how much generating capacity the electrical power system 10 must have in reserve to meet the stability target according to the baseline operation of the electrical power system 10 without the contingency 12-n. In other embodiments, for each of the different contingencies 12, calculating the dimension-specific score 17-n for the stability dimension comprises calculating the dimension-specific score 17-n alternatively or additionally as a function of an estimated cost that would be incurred by an operator of the electrical power system 10 to implement control measures to mitigate an increase in generating capacity which the electrical power system 10 must have in reserve to meet a stability target according to simulated operation of the electrical power system 10 under the contingency 12-n, relative to the baseline operation of the electrical power system 10 without the contingency 12-n.

In some embodiments where how impactful the individual outage of the respective piece of equipment 10-1 . . . 10-N would be is quantified across multiple dimensions of the electrical power system's performance, for each of the multiple dimensions, calculating the dimension-specific score 17-n for the dimension comprises calculating a raw score for the dimension to characterize performance of the electrical power system 10 in that dimension during the simulated operation of the electrical power system 10 under the contingency 12-n, relative to performance of the electrical power system 10 in the dimension during baseline operation of the electrical power system 10 without the contingency 12-n, and calculating the dimension-specific score 17-n for the dimension by normalizing the raw score for the dimension to fall within a dimension-agnostic range, wherein raw scores for different respective dimensions are normalized to fall within the same dimension-agnostic range.

In some embodiments where how impactful the individual outage of the respective piece of equipment 10-1 . . . 10-N would be is quantified across multiple dimensions of the electrical power system's performance, for each of the different contingencies 12, synthesizing the dimension-specific scores 17-1 . . . 17-X for the multiple dimensions into a unified criticality score for the piece of equipment 10-1 . . . 10-N comprises, for each of the different contingencies 12, calculating the unified criticality score for the piece of equipment 10-1 . . . 10-N as a function of a weighted combination of the dimension-specific scores 17-1 . . . 17-X for the multiple dimensions. In some embodiments, for each of the different contingencies 12, synthesizing the dimension-specific scores 17-1 . . . 17-X for the multiple dimensions into a unified criticality score for the piece of equipment 10-1 . . . 10-N comprises, for each of the different contingencies 12, calculating the unified criticality score for the piece of equipment 10-1 . . . 10-N as a function. In some embodiments, the function includes the dimension-specific scores 17-1 . . . 17-X for the multiple dimensions and is also a function of an age of the piece of equipment 10-1 . . . 10-N. In other embodiments, the function includes the dimension-specific scores 17-1 . . . 17-X for the multiple dimensions and is also a function alternatively or additionally of an estimated cost to repair the piece of equipment 10-1 . . . 10-N and/or to access the piece of equipment 10-1 . . . 10-N for repair. In yet other embodiments, the function includes the dimension-specific scores 17-1 . . . 17-X for the multiple dimensions and is also a function alternatively or additionally of availability of parts for the piece of equipment 10-1 . . . 10-N in inventory. In still yet other embodiments, the function includes the dimension-specific scores 17-1 . . . 17-X for the multiple dimensions and is also a function alternatively or additionally of an estimated duration of time required to repair the piece of equipment 10-1 . . . 10-N and/or an estimated duration of time required to order and receive a replacement of the piece of equipment 10-1 . . . 10-N. In still yet other embodiments, the function includes the dimension-specific scores 17-1 . . . 17-X for the multiple dimensions and is also a function alternatively or additionally of an availability of a temporary replacement for the piece of equipment 10-1 . . . 10-N to maintain operations while waiting for a permanent replacement for the piece of equipment 10-1 . . . 10-N. In still yet other embodiments, the function includes the dimension-specific scores 17-1 . . . 17-X for the multiple dimensions and is also a function alternatively or additionally of a frequency of past failures and/or historical reliability data for the piece of equipment 10-1 . . . 10-N. In still yet other embodiments, the function includes the dimension-specific scores 17-1 . . . 17-X for the multiple dimensions and is also a function alternatively or additionally of an extent of redundancy within the electrical power system 10 for the piece of equipment 10-1 . . . 10-N.

In some embodiments, controlling or assisting with controlling comprises making one or more decisions about how the electrical power system 10 is to be controlled, or is recommended to be controlled, to account for the criticality scores 18-1 . . . 18-N for the pieces of equipment 10-1 . . . 10-N. The decision(s) in this regard may be decision(s) about whether and/or how to adjust one or more operational parameters of the electrical power system 10 to account for the criticality scores 18-1 . . . 18-N for the pieces of equipment 10-1 . . . 10-N. In this case, controlling or assisting with controlling may include transmitting, displaying, or otherwise indicating to an operator of the electrical power system 10 planned or recommended adjustments to the one or more operational parameters to account for the criticality scores 18-1 . . . 18-N for the pieces of equipment 10-1 . . . 10-N. Alternatively or additionally, controlling or assisting with controlling may include dynamically adjusting the one or more operational parameters of the electrical power system 10 according to the decision(s) about how to do so.

Alternatively or additionally, controlling or assisting with controlling may include dynamically adjusting a graphical user interface of operational control equipment 20 of the electrical power system 10 to account for the criticality scores 18-1 . . . 18-N for the pieces of equipment 10-1 . . . 10-N. In some embodiments, this may involve adjusting a visual representation of one or more of the pieces of equipment on the graphical user interface to reflect the one or more respective criticality scores 18-1 . . . 18-N for the one or more of the pieces of equipment 10-1 . . . 10-N. In other embodiments, dynamically adjusting comprises dynamically adjusting the graphical user interface of the operational control equipment 20 of the electrical power system 10 by triggering an alert notification on the graphical user interface. In some embodiments, the alert notification is a notification of an event triggered by one or more of the criticality scores 18-1 . . . 18-N.

In any of these embodiments involving operational parameter(s) of the electrical power system 10, the one or more operational parameters of the electrical power system 10 include one or more parameters that govern load shedding by the electrical power system 10. In other embodiments, the one or more operational parameters of the electrical power system 10 alternatively or additionally include one or more parameters that govern voltage and/or frequency regulation by the electrical power system 10. In yet other embodiments, the one or more operational parameters of the electrical power system 10 alternatively or additionally include one or more parameters that govern energy storage by the electrical power system 10. In still yet other embodiments, the one or more operational parameters of the electrical power system 10 alternatively or additionally include one or more parameters that govern integration of renewable energy sources into the electrical power system 10. In still yet other embodiments, the one or more operational parameters of the electrical power system 10 alternatively or additionally include one or more parameters that govern participating by the electrical power system 10 in a bulk energy market. In still yet other embodiments, the one or more operational parameters of the electrical power system 10 alternatively or additionally include one or more parameters that govern power flow control and network reconfiguration within the electrical power system 10. In still yet other embodiments, the one or more operational parameters of the electrical power system 10 alternatively or additionally include one or more parameters that govern the coordination between transmission and distribution systems within the electrical power system 10. In still yet other embodiments, the one or more operational parameters of the electrical power system 10 alternatively or additionally include one of more parameters that govern congestion limits in line flows affecting market clearing prices.

In some embodiments, said simulating comprises simulating operation of the electrical power system 10 under the different contingencies 12 according to one or more power system files that reflect a topology of the electrical power system 10, a location of generation and loads with respect to the topology, and a location of the pieces of equipment with respect to the topology.

Embodiments herein also include corresponding apparatuses. Embodiments herein for instance include computing equipment configured to perform any of the steps of any of the embodiments described above. The computing equipment may be operational control equipment 20 or be communicatively coupled to operational control equipment 20.

More particularly, the computing equipment may perform the methods herein and any other processing by implementing any functional means, modules, units, or circuitry. In one embodiment, for example, the computing equipment comprises respective circuits or circuitry configured to perform the steps shown in FIG. 6. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for carrying out one or more of the techniques described herein, in several embodiments. In embodiments that employ memory, the memory stores program code that, when executed by the one or more processors, carries out the techniques described herein.

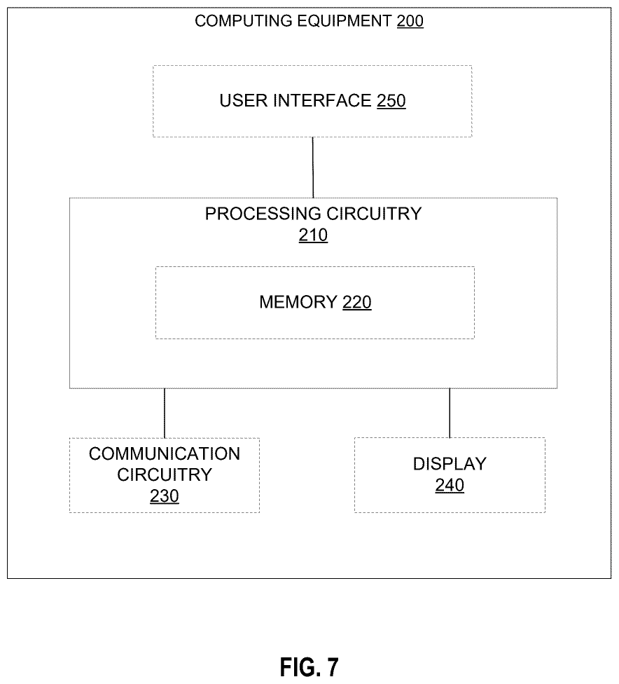

FIG. 7 illustrates one example of computing equipment 200 according to some embodiments. The computing equipment 200 may be operational control equipment 20, or may be communicatively coupled to operational control equipment 20. As shown, the computing equipment 200 includes processing circuitry 210. The processing circuitry 210 is configured to perform the processing described above, e.g., in FIG. 6, such as by executing instructions stored in memory 220. The processing circuitry 210 in this regard may implement certain functional means, units, or modules.

In some embodiments, the computing equipment 200 further includes communication circuitry 230. Such communication circuitry 230 may be configured to receive information as input to contingency analysis 14 and/or as input to criticality scoring 16. Alternatively or additionally, communication circuitry 230 may be configured to transmit criticality scores 18-1 . . . 18-N to other equipment, e.g., to operational control equipment 20 in embodiments where computing equipment 200 is separate equipment.

In some embodiments, such as where the computing equipment 200 is the operational control equipment 20, the computing equipment 200 also includes a display 240. The display 240 may be configured to display the graphical user interface of operational control equipment 20, e.g., as controlled according to embodiments herein. In these and other embodiments, the computing equipment 200 may also include a user interface 250, e.g., for interaction by a user with the computing equipment 200. The user interface 250 may for instance enable the user to trigger or perform one or more system control actions based on the graphical user interface that accounts for the criticality scores 18-1 . . . 18-N for the pieces of equipment 10-1 . . . 10-N.

Those skilled in the art will also appreciate that embodiments herein further include corresponding computer programs.

A computer program comprises instructions which, when executed on at least one processor of computing equipment 200, cause the computing equipment 200 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of computing equipment 200, cause the computing equipment 200 to perform as described above.

Embodiments further include a computer program product comprising program code portions for performing the steps of any of the embodiments herein when the computer program product is executed by computing equipment 200. This computer program product may be stored on a computer readable recording medium.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole.

What is claimed is:

1. A method comprising:
executing contingency analysis by simulating operation of an electrical power system under different contingencies that reflect an individual outage of different respective pieces of equipment in the electrical power system;
for each of the different contingencies, quantifying how impactful the individual outage of the respective piece of equipment would be across multiple dimensions of the electrical power system's performance, by:
for each of the multiple dimensions, calculating a dimension-specific score which characterizes performance of the electrical power system in that dimension according to the simulated operation of the electrical power system under the contingency, relative to performance of the electrical power system in the dimension according to baseline operation of the electrical power system without the contingency; and
synthesizing the dimension-specific scores for the multiple dimensions into a unified criticality score for the piece of equipment; and
based on the unified criticality scores for the pieces of equipment, controlling, or assisting with controlling, operation of the electrical power system.

2. The method of claim 1, wherein the multiple dimensions of the electrical power system's performance include two or more of:
an operational standards dimension reflecting an extent to which the electrical power system complies with or violates defined operational standards;
a service dimension reflecting an extent to which the electrical power system is able or unable to provide electrical power service to customers;
a price dimension reflecting market pricing of electrical power provided by the electrical power system; and/or
a stability dimension reflecting an extent to which the electrical power system is stable or unstable.

3. The method of claim 1, wherein the multiple dimensions of the electrical power system's performance include an operational standards dimension reflecting an extent to which the electrical power system complies with or violates defined operational standards, wherein the defined operational standards comprise standards defined for bus voltage limits, branch current limits, equipment power ratings, and/or stability margins, wherein, for each of the different contingencies, calculating the dimension-specific score for the operational standards dimension comprises calculating the dimension-specific score as a function of one or more of:
a total number of violations of the defined operational standards resulting from the simulated operation of the electrical power system under the contingency; and/or
a magnitude of each violation of the defined operational standards resulting from the simulated operation of the electrical power system under the contingency.

4. The method of claim 1, wherein the multiple dimensions of the electrical power system's performance include a service dimension reflecting an extent to which the electrical power system is able or unable to provide electrical power service to customers, wherein, for each of the different contingencies, calculating the dimension-specific score for the service dimension comprises calculating the dimension-specific score as a function of one or more of:
how much less electrical power the electrical power system is able to provide to customers according to simulated operation of the electrical power system under the contingency, relative to how much electrical power the electrical power system is able to provide to customers according to the baseline operation of the electrical power system without the contingency; and/or
how many and/or which one or more types of customers are unable to be provided electrical power from the electrical power system according to simulated operation of the electrical power system under the contingency, relative to how many and/or which one or more types of customers are able to be provided electrical power from the electrical power system according to the baseline operation of the electrical power system without the contingency.

5. The method of claim 1, wherein the multiple dimensions of the electrical power system's performance include a price dimension reflecting market pricing of electrical power provided by the electrical power system, wherein, for each of the different contingencies, calculating the dimension-specific score for the price dimension comprises calculating the dimension-specific score as a function of one or more of:
for each of one or more locations served by the electrical power system, how much a locational marginal price of electrical power provided by the electrical power system increases for the location according to simulated operation of the electrical power system under the contingency, relative to the baseline operation of the electrical power system without the contingency;
how many locations served by the electrical power system see at least a threshold increase in a locational marginal price of electrical power provided by the electrical power system according to simulated operation of the electrical power system under the contingency, relative to the baseline operation of the electrical power system without the contingency;
an estimated cost that would be incurred by an operator of the electrical power system to implement control measures to mitigate, for one or more locations, an increase in a locational marginal price of electrical power provided by the electrical power system according to simulated operation of the electrical power system under the contingency, relative to the baseline operation of the electrical power system without the contingency; and/or
an estimated loss of revenue suffered by an operator of the electrical power system attributable to occurrence of the contingency.

6. The method of claim 1, wherein the multiple dimensions of the electrical power system's performance include a stability dimension reflecting an extent to which the electrical power system is stable or unstable, wherein, for each of the different contingencies, calculating the dimension-specific score for the stability dimension comprises calculating the dimension-specific score as a function of one or more of:
how much more generating capacity the electrical power system must have in reserve to meet a stability target according to simulated operation of the electrical power system under the contingency, relative to how much generating capacity the electrical power system must have in reserve to meet the stability target according to the baseline operation of the electrical power system without the contingency; and/or
an estimated cost that would be incurred by an operator of the electrical power system to implement control measures to mitigate an increase in generating capacity which the electrical power system must have in reserve to meet a stability target according to simulated operation of the electrical power system under the contingency, relative to the baseline operation of the electrical power system without the contingency.

7. The method of claim 1, wherein, for each of the multiple dimensions, calculating the dimension-specific score for the dimension comprises:
calculating a raw score for the dimension to characterize performance of the electrical power system in that dimension during the simulated operation of the electrical power system under the contingency, relative to performance of the electrical power system in the dimension during baseline operation of the electrical power system without the contingency; and
calculating the dimension-specific score for the dimension by normalizing the raw score for the dimension to fall within a dimension-agnostic range, wherein raw scores for different respective dimensions are normalized to fall within the same dimension-agnostic range.

8. The method of claim 1, wherein, for each of the different contingencies, synthesizing the dimension-specific scores for the multiple dimensions into a unified criticality score for the piece of equipment comprises, for each of the different contingencies, calculating the unified criticality score for the piece of equipment as a function of a weighted combination of the dimension-specific scores for the multiple dimensions.

9. The method of claim 8, wherein, for each of the different contingencies, synthesizing the dimension-specific scores for the multiple dimensions into a unified criticality score for the piece of equipment comprises, for each of the different contingencies, calculating the unified criticality score for the piece of equipment as a function of the dimension-specific scores for the multiple dimensions and also as a function of one or more of:
a voltage class of the piece of equipment; or
an electrical power rating of the piece of equipment.

10. The method of claim 1, wherein, for each of the different contingencies, synthesizing the dimension-specific scores for the multiple dimensions into a unified criticality score for the piece of equipment comprises, for each of the different contingencies, calculating the unified criticality score for the piece of equipment as a function of the dimension-specific scores for the multiple dimensions and also as a function of one or more of:
an age of the piece of equipment;
an estimated cost to repair the piece of equipment and/or to access the piece of equipment for repair;
availability of parts for the piece of equipment in inventory;
an estimated duration of time required to repair the piece of equipment and/or an estimated duration of time required to order and receive a replacement of the piece of equipment;
an availability of a temporary replacement for the piece of equipment to maintain operations while waiting for a permanent replacement for the piece of equipment;
a frequency of past failures and/or historical reliability data for the piece of equipment;
an extent of redundancy within the electrical power system for the piece of equipment.

11. The method of claim 1, wherein said controlling or assisting with controlling comprises making one or more decisions about how the electrical power system is to be controlled, or is recommended to be controlled, to account for the unified criticality scores for the pieces of equipment.

12. The method of claim 11, wherein the one or more decisions comprises one or more decisions about whether and/or how to adjust one or more operational parameters of the electrical power system to account for the unified criticality scores for the pieces of equipment.

13. The method of claim 12, wherein the one or more operational parameters of the electrical power system include one or more of:
one or more parameters that govern load shedding by the electrical power system;
one or more parameters that govern voltage and/or frequency regulation by the electrical power system;
one or more parameters that govern energy storage by the electrical power system;
one or more parameters that govern integration of renewable energy sources into the electrical power system;
one or more parameters that govern participating by the electrical power system in a bulk energy market;
one or more parameters that govern power flow control and network reconfiguration within the electrical power system;
one or more parameters that govern the coordination between transmission and distribution systems within the electrical power system; and/or
one of more parameters that govern congestion limits in line flows affecting market clearing prices.

14. The method of claim 12, wherein said controlling or assisting with controlling comprises transmitting, displaying, or otherwise indicating to an operator of the electrical power system planned or recommended adjustments to the one or more operational parameters to account for the unified criticality scores for the pieces of equipment.

15. The method of claim 12, wherein said controlling or assisting with controlling comprises implementing the one or more decisions by dynamically adjusting the one or more operational parameters.

16. The method of claim 1, wherein said controlling or assisting with controlling comprises dynamically adjusting a graphical user interface of the operational control equipment of the electrical power system to account for the unified criticality scores for the pieces of equipment.

17. The method of claim 16, wherein said dynamically adjusting comprises one or more of:
adjusting a visual representation of one or more of the pieces of equipment on the graphical user interface to reflect the one or more respective unified criticality scores for the one or more of the pieces of equipment; or
triggering an alert notification on the graphical user interface, wherein the alert notification is a notification of an event triggered by one or more of the unified criticality scores.

18. The method of claim 1, wherein said simulating comprises simulating operation of the electrical power system under the different contingencies according to one or more power system files that reflect:
a topology of the electrical power system;
a location of generation and loads with respect to the topology; and
a location of the pieces of equipment with respect to the topology.

19. A non-transitory computer-readable storage medium on which is stored instructions that, when executed by one or more processors of computing equipment, cause the computing equipment to:
execute contingency analysis by simulating operation of an electrical power system under different contingencies that reflect an individual outage of different respective pieces of equipment in the electrical power system;
for each of the different contingencies, quantify how impactful the individual outage of the respective piece of equipment would be across multiple dimensions of the electrical power system's performance, by:
for each of the multiple dimensions, calculating a dimension-specific score which characterizes performance of the electrical power system in that dimension according to the simulated operation of the electrical power system under the contingency, relative to performance of the electrical power system in the dimension according to baseline operation of the electrical power system without the contingency; and
synthesizing the dimension-specific scores for the multiple dimensions into a unified criticality score for the piece of equipment; and
based on the unified criticality scores for the pieces of equipment, control, or assist with controlling, operation of the electrical power system.

20. The non-transitory computer-readable storage medium of claim 19, wherein the stored instructions, when executed by one or more processors of computing equipment, cause the computing equipment to:
make one or more decisions about how the electrical power system is to be controlled, or is recommended to be controlled, to account for the unified criticality scores for the pieces of equipment, wherein the one or more decisions comprises one or more decisions about whether and/or how to adjust one or more operational parameters of the electrical power system to account for the unified criticality scores for the pieces of equipment; and
transmit, display, or otherwise indicate to an operator of the electrical power system planned or recommended adjustments to the one or more operational parameters to account for the unified criticality scores for the pieces of equipment, and/or implement the one or more decisions by dynamically adjusting the one or more operational parameters.

21. Computing equipment of an electrical power system, the computing equipment comprising:
processing circuitry configured to:
execute contingency analysis by simulating operation of an electrical power system under different contingencies that reflect an individual outage of different respective pieces of equipment in the electrical power system;
for each of the different contingencies, quantify how impactful the individual outage of the respective piece of equipment would be across multiple dimensions of the electrical power system's performance, by:
for each of the multiple dimensions, calculating a dimension-specific score which characterizes performance of the electrical power system in that dimension according to the simulated operation of the electrical power system under the contingency, relative to performance of the electrical power system in the dimension according to baseline operation of the electrical power system without the contingency; and
synthesizing the dimension-specific scores for the multiple dimensions into a unified criticality score for the piece of equipment; and
based on the unified criticality scores for the pieces of equipment, control, or assist with controlling, operation of the electrical power system.

22. The computing equipment of claim 21, wherein the processing circuitry is further configured to:
make one or more decisions about how the electrical power system is to be controlled, or is recommended to be controlled, to account for the unified criticality scores for the pieces of equipment, wherein the one or more decisions comprises one or more decisions about whether and/or how to adjust one or more operational parameters of the electrical power system to account for the unified criticality scores for the pieces of equipment; and
transmit, display, or otherwise indicate to an operator of the electrical power system planned or recommended adjustments to the one or more operational parameters to account for the unified criticality scores for the pieces of equipment, and/or implement the one or more decisions by dynamically adjusting the one or more operational parameters.
